(19) United States
(12) Patent Application Publication
(10) Pub. No.: US 2012/0216563 A1
(43) Pub. Date: Aug. 30, 2012

(54) SURFACE FEEDING AND DISTRIBUTION OF A REFRIGERANT FOR A HEAT EXCHANGER IN SORPTION MACHINES

(75) Inventors: Niels Braunschweig, Berlin (DE); Soeren Paulussen, Berlin (DE); Andrej Laufer, Berlin (DE)

(73) Assignee: INVENSOR GMBH, Berlin (DE)

(21) Appl. No.: 13/393,892

(22) PCT Filed: Sep. 2, 2010
(86) PCT No.: PCT/DE10/01054

§ 371 Date: May 15, 2012

(30) Foreign Application Priority Data
Sep. 2, 2009 (DE) 10 2009 040 248.9
Nov. 18, 2009 (DE) 10 2009 053 843.7

(51) Int. Cl. F25B 39/02; B23P 15/26

(52) U.S. Cl. 62/515; 29/890.03

(57) ABSTRACT

The invention relates to an evaporator for sorption machines, comprising a heat exchanger provided with at least one tube and/or preferably tubular accessories, and a porous material which allows vapour to pass through is in contact with the tubes and/or the tubular accessories. The invention also relates to the use of fibrous material as filing material in an evaporator.

The invention is directed at an evaporator for sorption machines, comprising a heat exchanger provided with tubes and/or tubular accessories, but preferably the latter, and a porous material which allows vapour to pass through is in contact with the tubes and/or the tubular accessories. The invention also relates to the use of fibrous material as filling material in an evaporator.

Sorption machines usually consist of one or more sorbers, a condenser and an evaporator. In the evaporator, the refrigerant changes from a liquid to a gaseous phase. During this process, heat is extracted from the refrigerant. This is, therefore, the actual refrigeration process. The driving force of this process is the reduction in vapour pressure due to the sorption processes and the evaporation of refrigerant due to the thermal energy transferred from the heat transfer fluid.

The evaporator/heat exchanger is usually provided with low-temperature heat via a heat transfer fluid (e.g. air, water, brine, etc.). The lower the temperature difference between the heat transfer fluid and the refrigerant, the more efficient the evaporator/heat exchanger and thus the sorption machine itself.

In general, sorption machines are systems which use water as a refrigerant, e.g. in the common substance combinations: lithium bromide/water (absorption) or silica gel/water (adsorption) or zeolite/water (adsorption). Water only evaporates at low temperatures in the negative pressure range (e.g. at 10 C and 12.3 mbar absolute). Therefore, sorption machines are usually vacuum reactors operated at negative pressure. The very low absolute pressure results in certain peculiarities and boundary conditions regarding evaporator design which usually means that classic evaporator types from e.g. vapour-compression refrigeration machines are not used as classic vapour-compression machines usually use refrigerant which works in the positive pressure range. As an example, operation in the negative pressure range leads to very low densities and high specific volumes of the refrigerant. This then leads to the refrigerant vapours having unusually high flow rates so that a generous dimensioning of the vapour flow paths within the system is particularly important. Nevertheless, vapour flow rates of >50 m/s or 100 m/s are quite common in sorption machines.

Due to the low absolute pressure, the hydrostatic pressure of the liquid refrigerant must not be neglected and is an important design criterion. Depending on the filling level, this pressure can amount to several mbar which has considerable a effect on the evaporation process at an operating pressure of only a few mbar absolute.

Moreover, sorption machine evaporators are not usually operated in the boiling range as this would mean a driving minimum temperature difference which is not usually desirable or acceptable for sorption machines.

An evaporator type which is very common in the area of absorption machines (liquid sorption) is the falling film evaporator. It uses a circulation pump to circulate the refrigerant and pass it over the heat exchange surface in a thin film by means of suitable distribution systems. This produces very high heat transfer coefficients as both the turbulence in the film and the very low thickness of the film have a positive effect on the evaporation process for example.

In the area of adsorption heat pumps, there is also the flooded evaporator approach. In this case, a heat exchanger is flooded with the refrigerant. The heat transfer fluid therefore flows in the tubes or channels of the heat exchanger. Surface-enlarging elements are usually attached to the tubes of the heat exchanger, such as fins or ribs.

As sorption machines often take the form of vacuum reactors, the use of actively moving elements such as valves or circulation pumps must be considered disadvantageous as these components pose large problems with regard to vacuum tightness and maintainability. As a general rule, pumps or valves should naturally also be avoided to save money and energy. It is therefore particularly appropriate not to use a falling film evaporator for adsorption machines in order to avoid the use of circulation pumps.

If using a flooded evaporator instead, it becomes evident that the flooded heat exchanger surface, i.e. the surface underneath the water surface, is only available for effective heat transfer to a limited extent. In particular, surface-enlarging elements are not very effective for heat transfer as they may be flooded by the refrigerant. This can be partially explained by the hydrostatic pressure of the refrigerant but also by the blocked vapour path which would lead through the liquid refrigerant in case of evaporation underneath the refrigerant surface.

One way of overcoming these disadvantages was to build evaporators with a complex design which evaporate the refrigerant on various flat planes. In addition to the complex design—such as refrigerant overflow, collecting trays for the refrigerant on each plane—this also poses the problem that, even though the refrigerant can be distributed relatively well on the planes during operation if the tray sizes and overflows are designed particularly well, the heat exchanger surfaces are no longer well wetted in case of a standstill without continuous refrigerant supply or in case of reduced output with reduced refrigerant supply. This leads to reduced evaporator efficiency, in the case of a spontaneous increase in evaporator output in particular.

All evaporators described in the state of the art also have the common disadvantage in that such apparatus is very sensitive when it comes to inclination of the apparatus, centrifugal forces acting on the refrigerant or other boundary conditions which may interfere with the refrigerant application or distribution. In general, state-of-the-art evaporators must be carefully adjusted at the place of installation and are not suitable for mobile applications.

Methods and apparatus with the aim of improving the evaporator efficiency are described as state of the art.

For example, WO 2008/155543 A2 discloses a heat pump comprising two adsorption beds, each bed including a heat exchanger. A gas is used as a refrigerant which adsorbs onto an adsorption material. Thanks to an energy input, the gas can be desorbed from the adsorption material. To improve thermal conductivity, heat-conducting materials can be integrated into the adsorption material. The materials may, for example, be made of copper or aluminum and be integrated into the adsorption material in various forms. These forms include flakes, foams, fibres or meshes. The disclosed heat pump has to use a compressor to pump the refrigerant. This requires the use of moving components in the heat pump which may result in regular maintenance costs for example. Moreover, the use of pumps or values should be avoided to save money and energy. However, WO 2008/155543 A2 does not describe how to improve evaporator capacity.

Furthermore, US 2009/0249825 A1 discloses a heat pump comprising a condenser/evaporator. The condenser/evaporator wall is coated with a thin matrix for the bonding of an active substance (e.g. LiCl). Depending on the operating mode of the heat pump, the active substance undergoes a change from a liquid to a solid state and vice-versa. Preferably, the matrix comprises an inert material, such as aluminum oxide. The disadvantage of the disclosed heat pump is that it requires a large surface onto which the matrix must be applied. Therefore, in order to improve efficiency, a large heat pump must be provided which not only leads to an increase in weight but also in production costs. The heat pump also comprises a plurality of components, including the active substance, the matrix and a refrigerant. For this reason, operation of the heat pump is particularly susceptible to failure.

The aim of the invention was therefore to provide an evaporator for an evaporation process in the negative pressure range which is free of the disadvantages of the state of the art.

Surprisingly, this problem is solved by the features of independent claims. Preferred embodiments of the invention are disclosed in the subclaims.

It came as a surprise that an evaporator can be provided for a sorption machine which comprises a heat exchanger provided with at least one tube, channel and/or combination of both through which a fluid passes through, to which a refrigerant is at least partially applied, wherein the evaporator is filled with, in particular, porous material which allows vapour to pass through and is at least partially in contact with the tube, the channel and/or the combination. It was even more surprising that an evaporator can be provided which is free of the disadvantages of the evaporators described in the state of the art and merely comprises a heat exchanger and the porous material which is preferably inserted into the evaporator as a bed. Advantageously, no further components, such as an active substance or active medium or a matrix, are required in the evaporator, i.e. the invention's evaporator is not provided with any active substance (or medium), such as LiCl, which undergoes a change of state. For the purposes of the invention, a bed particularly means a mixture of porous material in free-flowing form.

For the purposes of the invention, a heat exchanger means in particular an apparatus which transfers thermal energy from one material flow to another. For example, a material flow which is passed through the tubes of the heat exchanger is a heat transfer medium, preferably comprising water. This can, for example, be water in combination with an antifreeze agent. Of course, further heat transfer mediums, such as thermal oils, are also possible. The medium transfers the thermal energy to a further material flow, such as a refrigerant. The heat exchangers are preferably made of metal, e.g. stainless steel, copper, aluminum and/or steel. However, it is also possible to use plastic, glass or ceramics as a material. Advantageously, the heat exchanger is a component of the evaporator. For the purposes of the invention, the heat exchanger can also be used as evaporator.

For the purposes of the invention, a porous material, also referred to as material, is a material which has pores or which is permeable. For the purposes of the invention, a distinction can be made between fine and coarse porosity as well as between open (apparent) and closed porosity. Advantageous properties of the porous material are a strongly enlarged surface, capillarity or transport phenomena. Advantageously, the porous material can be present in the evaporator in solid and/or liquid form. Experts know that a solid material can, for example, be dissolved in liquids in order to prepare a slurry. For the purposes of the invention, a slurry specifically means a heterogeneous mixture of a liquid and solid matter dispersed therein. Experts know that a slurry can also be referred to as suspension or paste. It can also be advantageous to change the material from a solid to a liquid state and vice-versa.

For the purposes of the invention, a tube refers to an oblong hollow body, the length of which is usually considerably greater than its cross-sectional area. It may also have a rectangular, oval or other cross section.

For the purposes of the invention, a channel refers to a free cross section in a structure through which a medium can pass through. This free cross section can, e.g., be open to other free cross sections, as is the case in a plate heat exchanger. Experts know that tubes and channels can be equivalent means of conducting media.

The fluid which, for example, comprises water or another heat transfer medium, is passed through the tubes. The tubes are preferably made of metal, plastic and/or ceramic materials. Preferred variants include steel, stainless steel, cast iron, copper, brass, nickel alloys, aluminum alloys, plastics, combinations of plastics and metal (composite tube), combinations of glass and metal (enamel) or ceramics. Several tubes can be connected to each other in a force-fitting manner or by bonded connection. Force-fitted connections include clamp collars, fittings, bent tube sections, screws or rivets. Bonded connections include adhesion, welding, soldering or vulcanisation. Thanks to its good thermal conductivity, copper or aluminum is advantageous as tube material, whereas the use of stainless steel is also advantageous as it exhibits high static and dynamic strength values and high corrosion resistance. Tubes made of plastics, such as polyvinyl chloride, are particularly light and flexible and can therefore be used to reduce the weight of the heat exchanger. Ceramic materials, including structural ceramics, exhibit high stability and long durability. Combinations of the above materials are particularly advantageous as they allow for a combination of the different material properties. The preferred materials meet the high production requirements of heat exchangers by being resistant against temperatures and varying pressures.

Advantageously, the heat exchanger is provided with surface-enlarging tubular accessories or structures, in particular plates, nets, ribs, protrusions, 2- or 3-dimensional grid structures and/or fins. For the purposes of the invention, the surface-enlarging tubular accessories or structures include means of producing a surface enlargement of the tubes and/or channels and thus resulting in the heat exchange surface being enlarged. These means include plates, nets, ribs, protrusions, 2- or 3-dimensional grid structures and/or fins. These are preferably attached to the tubes at regular or irregular intervals. Experts are able to empirically determine an optimum arrangement of the surface-enlarging accessories by performing routine tests. The means are preferably made of metal, such as stainless steel, steel, copper or aluminum, as these exhibit high thermal conductivity coefficient and an optimum heat exchange, and ensure thermal conductivity. Experts know that a wide range of different materials can be used.

A fluid is passed through the tubes and/or channels or the heat exchanger and transfers thermal energy to the heat exchanger material. When operated in a sorption machine, e.g. an adsorption refrigeration machine, a refrigerant is passed through the machine, during which it undergoes a change of state. The heat exchanger is preferably used as an evaporator so that the refrigerant evaporates. To this end, the liquid refrigerant is fed into the heat exchanger and wets the surface of the heat exchanger tubes and/or the surface-enlarging tubular accessories. The refrigerant can also collect in trays or sumps which are preferably arranged in the evaporator. Advantageously, the refrigerant present in the trays or sumps is in contact with at least one surface of the heat exchanger. When direct contact is established between the refrigerant and the heat exchanger surface, which specifically includes the heat exchanger tubes and/or the surface-enlarging tubular accessories, thermal energy is transferred from the tubes and/or tubular accessories to the refrigerant causing the refrigerant to change state and transfer into the vapour phase. Advantageously, the heat exchanger or the tubes and/or tubular accessories are in contact with a particularly porous material through which vapour can pass through. The material is preferably inserted into the evaporator as a bed and advantageously fills the evaporator completely so that the liquid refrigerant can be optimally distributed in the evaporator by the material. The porous material preferably has high capillary forces so that the refrigerant is distributed in the evaporator by capillary forces of the bed as soon as it comes into contact with the material. The refrigerant therefore preferably wets the heat exchange surface of the heat exchanger in a thin film and evaporates with the vapour being able to pass through the structure of the material through which vapour is preferably able to pass through. Experiments have shown that evaporator efficiency is improved by the insertion of porous material through which vapour can pass through. Advantageously, an evaporator can be provided in which the heat exchanger surface does not need to be in direct contact with the refrigerant in the trays or sumps. The preferred evaporators can have smaller dimensions and can be produced without trays or sumps as the refrigerant is distributed in the evaporator by the porous material by means of capillary forces. Advantageously, the refrigerant can be inserted into the evaporator at any point. This further allows use of an evaporator, into which the porous material has been inserted as a bed, in an inclined position which is a considerable advantage over the evaporator disclosed in the state of the art. This means that due to the evaporator features according to the invention, it is not necessary to position it horizontally. The evaporator can be operated either horizontally or in an inclined position. For the purposes of the invention, an inclined position specifically means a non-horizontal position of the evaporator. As the porous material soaks up and stores the refrigerant independently of the given evaporator position, an evaporator of the invention also works in mobile applications in particular. In this case, even strong centrifugal forces or vibrations do not impair evaporator performance as the refrigerant is distributed on the evaporator or tubular accessories in an optimum manner at all times.

The porous material distributes the material fairly evenly in the evaporator, the heat exchanger in particular, without blocking the vapour produced in the evaporator in its flow path. Disadvantages, such as the hydrostatic pressure of the refrigerant and a suboptimal refrigerant distribution upon standstill or during part-load operation, are also avoided. The refrigerant is fed into the evaporator and preferably partially and/or fully taken up by the material and distributed in the material by the material's capillary forces. The material soaks up the refrigerant and stores and/or transports it so that the produced vapour flow is not subject to any drop in pressure.

The material is preferably at least partially in contact with the heat exchanger which causes thermal energy to be transferred to the material or to the refrigerant taken up by the material.

Similarly, the heat exchanger's heat-conducting surface and/or the accessories are advantageously wetted by a thin refrigerant film. The refrigerant evaporates thanks to the absorption of thermal energy transferred by the heat exchanger and/or the accessories. Thanks to the advantageous porous structure of the material, the vapour can escape and pass through the heat exchanger, preferably so that the vapour flow within the heat exchanger is not subject to any drop in pressure.

An advantageous evaporator does not require a pump or other actively moving parts to circulate the refrigerant and feed it into the evaporator. The refrigerant is fairly evenly distributed in the evaporator by the porous material. It is possible for the evaporator and sorption machine to operate effectively without high complexity of design. Furthermore, evaporator maintenance is made much easier and evaporator costs are reduced as it is possible to produce a compact and light-weight evaporator thanks to the materials. The advantageous evaporator meets the requirements for materials used under vacuum conditions. It exhibits surprisingly high chemical, thermal long-term stability which is required for various operating modes of the sorption machines in particular.

The porous material is preferably selected from the group consisting of sand, glass balls, glass fibres, clay, mineral wool, foam glass, cellulose, rigid foam, glass wool, metal wool, swarf, fibres, structures, microstructures or threads, rock wool, slag wool, expanded glass, perlite, calcium silicate, natural pumice, ceramic fibres, ceramic foam, silicate foam, plaster foam, pyrogenic silicic acid, flax, polyester fibres, phenolic foam, felt or a mixture thereof. For the purposes of the invention, sand refers to clastic rocks representing loose accumulations of rounded or angular grains, with a size of 0.06-2 mm in particular. Sand has particularly high capillary forces and high water-binding capacity. For the purposes of the invention, clay refers to a granular, unconsolidated sedimentary rock belonging to the cohesive sediments which essentially comprises mineral particles. Clay preferably has a soap-like consistency when moist and has high water-binding capacity, high swelling capacity and high adsorption capacity in comparison with many organic and inorganic substances. It may also be preferable to fill a slurry of an originally porous material into the evaporator, in which case the slurry would be a porous material for the purposes of the invention.

It was particularly surprising that the preferred porous materials may be used in an evaporator. Experts know that the preferred porous materials partially exhibit poor thermal conductivity or even none at all, meaning that experts would not use them in a heat-conducting process such as in an evaporator. However, experiments have shown that if the preferred porous material is inserted into the evaporator as a bed, the evaporator efficiency is considerably improved. The advantageous materials are porous and include a material attracting the refrigerant; the refrigerant is also transported within the porous material or in gaps of the porous material. Advantageously, the materials have many cavities and are light. Advantageously, the vapour produced by evaporating the refrigerant can pass through the cavities, ensuring the evaporator's continuous operation. The materials can be produced at low costs, and it is also possible to use waste products, which is particularly advantageous from an ecological point of view. The preferred porous materials exhibit high capillary forces and distribute the refrigerant in the evaporator in an optimum manner.

A preferred embodiment is the use of glass fibre as a porous material. Glass fibres are preferably thin threads made of glass with high tensile and compressive strength. The glass fibre preferably has an amorphous structure and isotropic mechanical properties. The glass fibres can be present in various strengths, e.g. 0.1-3 μm (thin glass fibres), 3-12 μm (light glass fibres), 12-35 μm (strong glass fibres), 35-100 μm (elastic glass fibres) and/or 100-300 μm (thick glass fibres). Advantageously, this allows production of different structures and forms from the glass fibres so that they can be adapted to various shapes and sizes of heat exchangers or evaporators. Moreover, the glass fibres may be made of special glass, such as fibre glass or glass comprising quartz glass, soda-lime glass, float glass, lead crystal glass and/or borosilicate glass. The glass fibres are preferably present in the form of glass fibre chips, cords, rovings, mats, fabric and/or beads. Glass fibre chips specifically refers to short sections of glass fibres with a length of 3 mm, with and/or without silane coating, but preferably with. However, they can also be coated with polyester resin or epoxy. Advantageously, glass fibre chips can be produced at particularly favourable costs. Furthermore, the structure of the chips surprisingly creates a highly porous filling material.

The glass fibres can also be processed in the form of glass fibre cords of virtually unlimited length or limited length. Here, structures such as yarn, strands, twist or twine can be inserted into the evaporator. The structures exhibit high capillary forces so that the refrigerant is also evenly distributed in evaporators of oblong design. Glass fibre rovings are preferably a certain number of glass fibres strands joined in parallel to form a string which can take up a large amount of refrigerant. Just like the glass fibre mats or glass fibre fabric, the glass fibre rovings can be used in evaporators which have to perform well.

The glass fibre beads are preferably round. However, experts know that oval or fairly round structures are also referred to as beads. It is also preferable that the different glass fibre structures are combined with each other. For example, glass fibre beads can be attached to a glass fibre cord. This combination considerably extends the area of application for glass fibres as a porous material in an evaporator, and all forms of evaporators can essentially be filled with the structures. It is also advantageous that the glass fibres can be easily processed, i.e. the material can be quickly and easily adapted to different operating modes of the sorption machines.

In a further embodiment, it is preferable that the material is applied to the tube, in particular by at least partially sheathing or coating the heat exchanger tubes with the material. Advantageously, the material can completely sheathe or coat the heat exchanger tubes. Here, the material can, for example, be operatively connected to at least one tube. The material can be attached to the tube by means of bonding connections, such as adhesion. Thanks to this arrangement, the refrigerant taken up by the material is brought in direct contact with the tube, i.e. with the heat exchange surface. This ensures efficient operation of the heat exchanger and the refrigerant can be quickly transferred into the vapour phase. However, the material may also only be located in close proximity to the tube without being in direct contact with it. It can also be advantageous to only partially connect the material to one or more tubes.

This may create areas—tubes without the material—which can be used for other devices, such as partition walls or valves.

Furthermore, another preferred embodiment comprises an evaporator in which the porous material is applied to the tubular accessories of the heat exchanger. The tubular accessories may be plates, nets, ribs, protrusions and/or fins. These accessories, preferably in heat-conducting contact with the heat exchanger tubes, increase the effective heat exchange surface of the heat exchanger. Consequently, it can be preferable that the material is also/only attached to the accessories or is at least located in close proximity to them. The material can also be bonded to the accessories. However, it can also be advantageous if the material is in contact with the accessories and/or the tubes. The variable incorporation of the material helps to retain flexibility which allows for quick and easy replacement of the material. The heat transfer medium passed through the tubes transfers thermal energy to the tubes and tubular accessories. The refrigerant is evenly distributed in the heat exchanger by the capillary forces of the porous material and causes the tubes and tubular accessories to at least partially fog up, advantageously creating a thin refrigerant film or drops or a drop structure on them. The refrigerant evaporates due to the thermal energy transferred from the heat transfer fluid and passes through the porous material. Thanks to the arrangement of the material in the evaporator and the form of the material itself, the vapour flow is not subject to any pressure drop. The preferred embodiment allows for the evaporators to be offered for sale as a unit and prevents the material from falling out of the evaporator during transport.

Advantageously, the tubular accessories are made of metal. It can be preferable to provide an evaporator in which the surface-enlarging tubular accessories and/or structures are porous. The porous tubular accessories and/or structures, including plates, nets, ribs, protrusions and/or fins, have a particularly porous surface which distributes the refrigerant by means of capillary forces and transfers thermal energy to the refrigerant. To this end, only the surface of the tubular accessories may be rendered porous. For example, this can be achieved by applying a porous layer onto the tubular accessories. However, it can also be advantageous to render the tubular accessories themselves porous, e.g. by oxidising the material, the surface in particular. Experts know that by means of a targeted oxidisation, surfaces are roughed up and become porous. The roughed-up surface has an enlarged and preferably porous surface which distributes the refrigerant by means of capillary forces, thus creating a thin liquid film on the surface which can be quickly transferred into the vapour state by thermal energy. The tubular accessories can also be made of metal fibres, wherein the refrigerant is transported through cavities formed between the fibres. Advantageously, the tubular accessories can be designed in the form of ribbed tubes where the refrigerant is distributed by the ribs by means of capillary forces. In a preferred embodiment, a hydrophilic layer is applied to the heat exchanger and/or the surface-enlarging tubular accessories and/or structures. The hydrophilic layer can be applied to the surface of the evaporator, particularly the heat exchanger, and/or surface-enlarging tubular accessories. For the purposes of the invention, hydrophilicity means that the applied layer attracts water and/or distributes water in a thin film. For example, this can be achieved by means of polymers or gels which cause the refrigerant to be distributed on the layer, or the surface, in a thin refrigerant film. By transferring thermal energy from the heat exchanger surface and/or the surface-enlarging tubular accessories and/or structures to the thin film, it is transferred into the vapour phase.

A plurality of tubes is preferably arranged in the heat exchanger in an essentially parallel arrangement creating gaps between these tubes.

A fluid, such as water or another heat transfer medium, is passed through the tubes and the tubes are arranged in such a manner that tube packs are created in one plane. For the purposes of the invention, tube packs refer to an accumulation of tubes, wherein the tube packs are preferably arranged in one plane in particular as a tube coil. The plane can be in a vertical or horizontal or any other position. Tubular accessories can be attached to the tubes in one plane.

For the purposes of the invention, gaps are cavities within the heat exchanger which do not contain any functional components. An alternating arrangement of the superposed tube packs and the gaps is advantageous, i.e. a gap is created between two superposed tube packs. A clearance, i.e. the gap, between two tube packs is preferably 0.2 to 1.0 cm, but 0.5 cm is most preferable. However, smaller or larger clearances may also be preferable. The tube packs can be arranged on top of each other at various angles. Here, a substantially parallel arrangement of the tube packs is advantageous. However, experts know that a substantially parallel arrangement also includes an arrangement of the tube packs which deviates from idealised parallelism by 5-10 degrees.

For example, the preferred arrangement of the tubes in the heat exchanger allows the incorporation of collecting trays into the gaps in which refrigerant preferably accumulates. The refrigerant present in the collecting trays is preferably in direct contact with the tubes and/or tubular accessories. The gaps further ensure that the refrigerant flows through the heat exchanger in an optimum manner so that all tubes and tubular accessories are preferably used as heat exchanger surface. This improves the heat exchanger's efficiency.

The material is preferably at least partially positioned on the tubes and in the gaps. The material can be easily inserted into the evaporator and is advantageously in contact with the heat exchanger's tubes and/or tubular accessories. The material can, for example, be applied to the tubes by bonded connections. The material can also essentially completely fill the gaps of the evaporator or heat exchanger. This ensures that the refrigerant is distributed in the evaporator in an optimum manner. The refrigerant is distributed in the material by the capillary forces of the material and can, therefore, also bridge the gaps which are free of tubes. It is possible to produce compact and light-weight evaporators in which the material brings the refrigerant into contact with the tubes and/or tubular accessories and in which an energy transfer takes place, causing the refrigerant to evaporate. Due to the evaporator's open structure—characterised by the gaps and the porous material—the refrigerant can flow through the evaporator and/or the heat exchanger. The vapour flow is preferably not subject to any drop in pressure and the evaporator efficiency is considerably improved.

It is also preferable that the glass fibre chips are at least partially of a length greater than the clearance between two fins or ribs. This preferred embodiment allows for easily filling the material into the evaporator. Moreover, the preferred length results in a preferred orientation of the material, i.e. the material is preferably present in the evaporator and heat exchanger with a certain orientation. This causes the refrigerant to be taken up well by the material. In addition, the contact surface between material and tube or tubular accessories is particularly large and the refrigerant is brought in direct contact with the tubes and/or tubular accessories, which in turn generates an optimum heat transfer.

The invention also relates to the use of a porous material as filling material in an evaporator. It can also be preferable that a material, a fibrous material in particular, is poured into the evaporator as filling material. For the purposes of the invention, a fibre is a thin and flexible structure comprising synthetic and/or natural components. The material, fibrous material in particular, can be applied to the tubes and/or tubular accessories of the evaporator, particularly the heat exchanger. However, it can also be preferable that the material, fibrous material in particular, is not applied to them but only arranged in close proximity to the tubes and/or tubular accessories.

It is also preferable that the evaporator comprises a heat exchanger provided with at least one tube, channel and/or a combination of both through which a fluid passes through, to which a refrigerant is at least partially applied, wherein the material substantially completely fills the evaporator and is in contact with the tube, channel and/or combination. The refrigerant is preferably soaked up by the porous material and distributed in the evaporator by means of capillary forces. The material, which is preferably used in the form of a fibrous material, distributes the refrigerant in the evaporator, particularly the heat exchanger's heat exchanger surfaces, in an optimum manner without blocking the refrigerant vapour formed therein in its further flow path. This allows the efficiency of the evaporator or heat exchanger to be considerably improved. Moreover, no instrumental components are required for circulation of the refrigerant in order to achieve distribution of the refrigerant in the evaporator. Surprisingly, an optimum refrigerant distribution is even ensured after standstill or in part-load operation of the evaporator.

Thanks to the advantageous physical and chemical properties of the porous material, the refrigerant can be attracted, transported and stored preferably for a short term without the created vapour flow being subject to any drop in pressure. Further advantages are that the evaporator efficiency can be improved without using circulation pumps or other actively moving parts under vacuum conditions. Moreover, compact evaporators which can be used in various areas can be provided. The porous material exhibits high chemical and thermal long-term stability and compatibility with the materials used in the evaporator or a sorption machine. It is also preferable that the porous material is inert and will not chemically react with the refrigerant and will also not change chemically.

Advantageously, the porous material allows production costs and the weight of the evaporator to be reduced. The evaporators can be individually manufactured for a specific process, and the material can be preferably filled into the evaporator as a filling material after completion of the evaporator. Advantageously, the material can also be immobilised on components of the heat exchanger, including e.g. tubes or channels. Immobilisation is implemented by means of adhesion and/or incorporation into cross-linked structures.

However, it can also be preferable that the heat exchanger has surface-enlarging tubular accessories or structures, selected from the group consisting of plates, nets, ribs, protrusions, 2- or 3-dimensional grid structures and/or fins, to which the material can preferably be attached or is attached. Thanks to the surface-enlarging components, the heat exchange surface is considerably enlarged so that the heat exchanger's efficiency is improved. The material can be poured into the evaporator and/or be fixed to the components. To do this, adhesives which create a permanent bond between component and material can be used. The material evenly distributes the refrigerant by means of capillary forces in the heat exchanger, the evaporator in particular.

The fibrous material is preferably selected from the group consisting of metal fibres, plaster fibres, anhydrite fibres, felt fibres, tobermorite fibres, wollastonite fibres, xonotlite fibres, rock wool fibres, cotton fibres, cellulose fibres, polyester fibres, polyamide fibres, methacrylic ester fibres, polyacrylic fibres, nitrile fibres, polyethylene fibres, polypropylene fibres and/or silicate fibres, glass fibres in particular. Advantageously, the different fibrous materials can be used for different evaporators depending on their operating mode and site of operation. However, it can also be advantageous to mix the fibrous materials or add, for example, metal swarf or wool which increase vapour permeability and/or thermal conductivity. Moreover, slurries of the fibres can be used which are filled into the evaporator. Experiments have shown that felt slurry in particular is advantageous and exhibits high capillary forces. The refrigerant can thus be distributed in the evaporator in an optimum manner with the slurries preventing the refrigerant vapour from escaping and passing through. The refrigerant is distributed in the fibrous material and in the evaporator by the capillary forces of the fibrous material and by diffusion forces which in turn creates optimum contact between the heat transfer surface—the tubes and/or the tubular accessories—and the refrigerant. In this manner, the evaporator's efficiency is improved. Moreover, an improved efficiency allows production of a smaller and more compact evaporator.

In a preferred embodiment, the fibrous material is inserted into the evaporator in the form of a slurry. The fibrous material can be broken up using mechanical devices for breaking up a wide range of different materials known by experts. The fibrous material can, for example, be chopped or shredded. The broken up material is preferably mixed with a liquid, such as water, thus producing a slurry. The slurry can be dried and fed into the evaporator as dried and porous slurry through which vapour can pass through. Surprisingly, it became evident that the dried slurry can be quickly and easily fed into the evaporator. Advantageously, the dried porous slurry can be filled into the evaporator by applying vibrations. To this end, the evaporator is preferably placed onto a vibrating device. Due to the vibrating motion, the porous slurry fills the evaporator and is distributed therein. The dried slurry completely fills the evaporator and forms vapour channels for the refrigerant during operation of the evaporator. However, it can also be preferable not to dry the slurry but to instead insert it into the evaporator when wet. The insertion may also be achieved by means of a vibrating device. Advantageously, the liquid used for preparing the slurry can be used as a refrigerant in the evaporator. The wet slurry is inserted into the evaporator and the liquid evaporates by means of thermal energy, the slurry forming vapour channels which allow the formed vapour to flow. It was surprising that the inserted slurry improves the evaporators efficiency as the refrigerant is distributed in the evaporator in an optimum manner due to the slurry and evaporates more quickly due to the contact with the heat exchange surfaces.

In the following, figures are used to describe the invention by way of example without being intended as limitations.

The figures show:

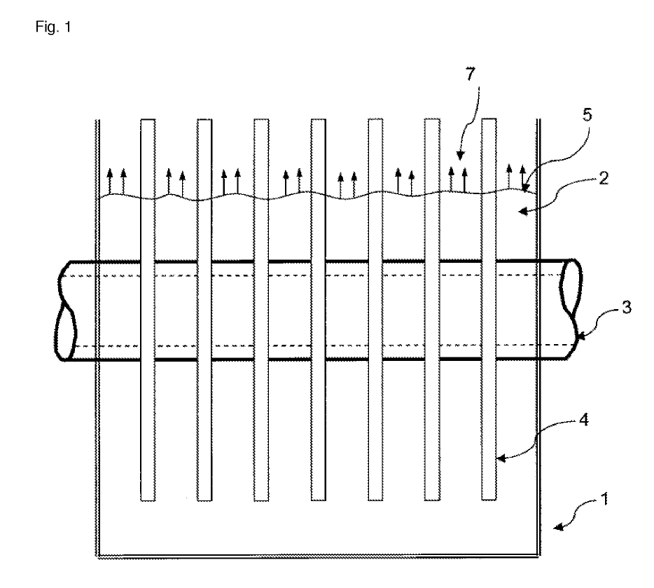

FIG. 1 Example of a heat exchanger described in the state of the art

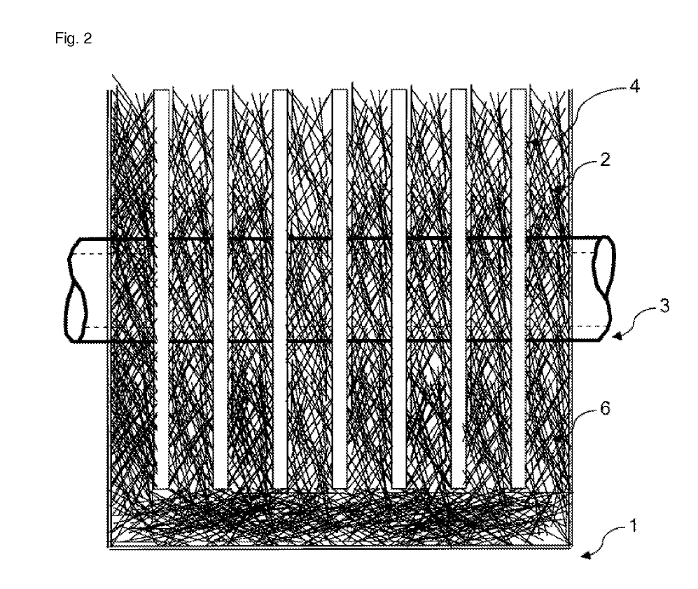

FIG. 2 Example of a heat exchanger of the invention

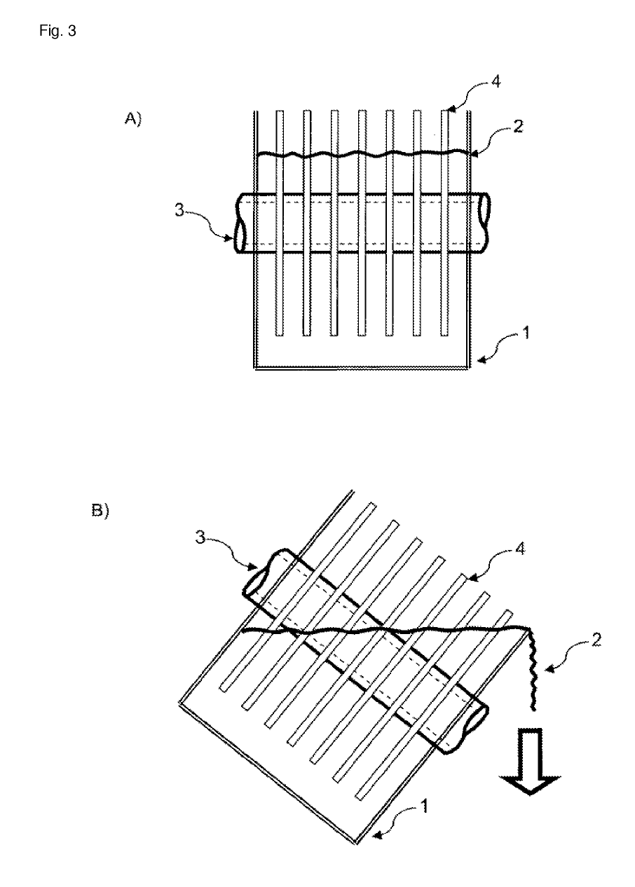

FIGS. 3A) and B) Tilting process of an evaporator described in the state of the art

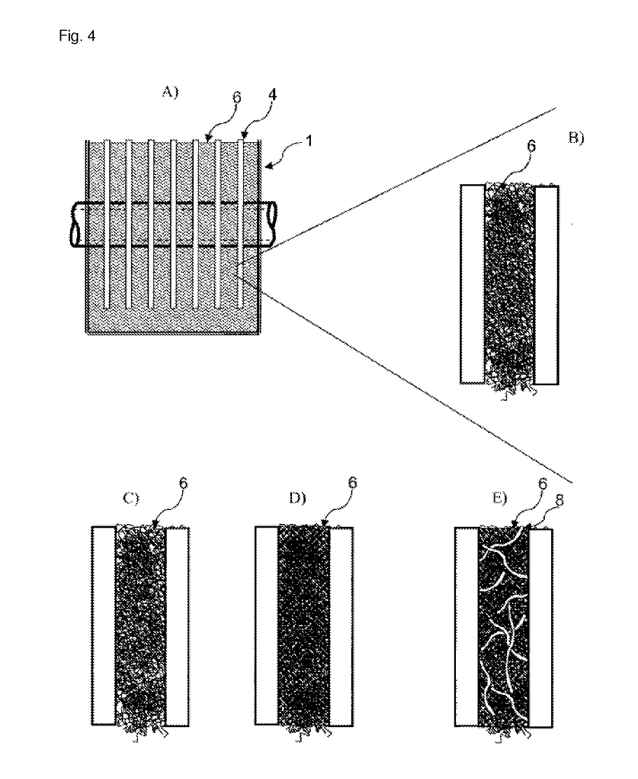

FIG. 4A)-E) Preferred evaporator with fibrous material

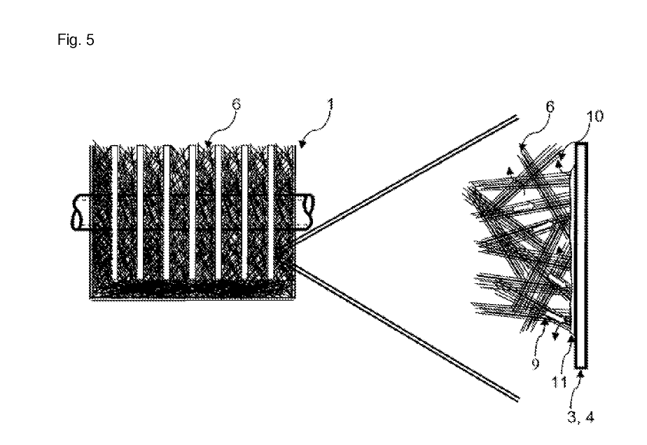

FIG. 5 Transport mechanism in a preferred evaporator

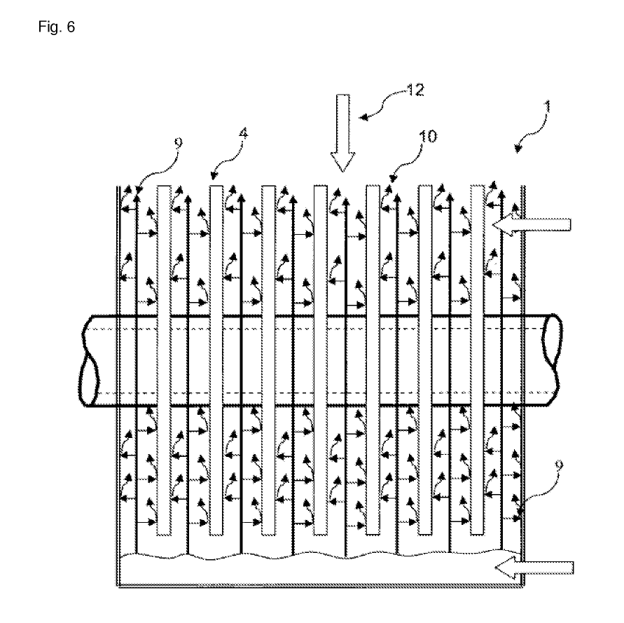

FIG. 6 Fluid flows in a preferred evaporator

FIG. 1 shows an example of a heat exchanger described in the state of the art. The heat exchanger (1) is flooded with the refrigerant (2), and the refrigerant (2) completely covers the tube (3). Similarly, the fins (4) are almost completely surrounded by the refrigerant (2). With the flooded heat exchanger (1) disclosed in the state of the art, it becomes evident that the flooded heat exchanger surface, i.e. the surface underneath the refrigerant surface (5), is only available for effective heat transfer to a limited extent or not at all (7). Moreover, the incorporation of surface-enlarging accessories (fins (4)) is not effective as they may be flooded by the refrigerant (2) and the refrigerant (2) hardly evaporates. The phase change of the refrigerant only occurs on the horizontal refrigerant surface (5).

FIG. 2 shows an example of the invention's heat exchanger. The heat exchanger (1) is filled with a porous material (6) which may, for example, comprise glass fibres. Various structures and forms of glass fibres can be used. Examples thereof are glass chips or glass fibre cords. The heat exchanger (1) is preferably completely filled with the material (6). However, it can also be preferable to only partially fill the heat exchanger (1). The material (6) can be directly connected to the tube (3) and/or tubular accessories, e.g. the fins (4). However, it can also be preferable to have the material (6) in contact with the tube (3) and/or tubular accessories (4) without being connected to them by means of a bonded connection. A refrigerant (2) incorporated into the heat exchanger (1) is taken up by the material (6) and distributed in the heat exchanger (1) by means of capillary forces. This allows an optimum distribution of the refrigerant (2) in the heat exchanger (1) to be achieved and the heat exchange surface to be enlarged. This improves the efficiency of the heat exchanger (1). Advantageously, the heat exchanger comprises tube packs which are arranged in planes. Preferably, gaps are created between the planes which can also be filled with the porous material.

FIGS. 3A) and B) outline a tilting process of an evaporator described in the state of the art. A disadvantage of the evaporators (1) described in the state of the art is that they must be positioned horizontally. When tilting the evaporator/heat exchanger (1), refrigerant escapes from the evaporator (1) so that this refrigerant is at first lost to the evaporator (1), cannot be evaporated and may have to be fed in again. Moreover, the tilting, which may also be caused by centrifugal forces, reduces utilisation of the heat exchange surface of the tubes (3) or tubular accessories (4). Advantageously, the evaporator of the invention can also be used in an inclined position.

FIG. 4A)-E) illustrate a preferred evaporator with fibrous material. FIG. 4A) shows an evaporator with fibrous material (6) in which the fibrous material (6) completely fills the evaporator (1) and is arranged between the tubular accessories (4). When dry, the fibrous material (6) is in particular completely vapour-permeable (see FIG. 4C)). FIG. 4B) shows an enlarged representation of the fibrous material (6) enclosed between the tubular accessories (4). FIG. 4E) represents a preferred fibrous material (6) in a dry state in the evaporator (1). When dry, the fibrous material (6) is vapour-permeable. FIG. 4D) shows that the take-up of the refrigerant and/or forming of a slurry or paste, which may help to achieve an improved filling of the fibrous material (6), leads to an almost complete closure of possible vapour paths or channels. FIG. 4E) shows that drying of the slurry and/or an initial vapour removal/vapour formation of the refrigerant creates vapour channels (8) which render the overall structure vapour-permeable again. The refrigerant vapour can flow through the slurry.

FIG. 5 outlines transport mechanisms which can occur in a preferred evaporator. The liquid refrigerant (9) (block arrows) is distributed in the evaporator (1) by means of the capillary forces of the porous material (6), for example glass fibres, and wets a heat exchanger surface comprising tubes (3) and/or tubular accessories (4) in a thin liquid film (11). Advantageously, the porous material (6) continuously transports liquid refrigerant (9) to the tubes (3) and/or tubular accessories which helps achieve a particularly constant wetting of the heat exchange surface with liquid refrigerant (9). Due to the input of thermal energy from the heat exchanger surface, the thin refrigerant film (11) can quickly evaporate. The produced vaporous refrigerant (10) can escape from the evaporator (1) through the porous structure of the material (6) which allows vapour to pass through.

FIG. 6 shows fluid flows in a preferred evaporator. The refrigerant can be inserted into the evaporator (1) at various points. FIG. 6 shows preferred inlets for the refrigerant (12). For example, the refrigerant can be fed into the evaporator from the top, bottom or centre. The porous material present in the evaporator (1) distributes the refrigerant in an optimum manner by means of capillary forces in the evaporator (1). The liquid refrigerant (9) is transported in the evaporator by the porous material which causes a refrigerant film to form on the heat exchanger surfaces. The film evaporates thanks to the input of thermal energy and the vaporous refrigerant (10) can escape through the porous material which allows vapour to pass through.

### REFERENCE LIST

1 heat exchanger/evaporator

2 refrigerant

3 tube

4 tubular accessories such as fins

5 refrigerant surface

6 porous material

7 heat transfer

8 vapour channels

9 liquid refrigerant

10 vaporous refrigerant

11 thin refrigerant film

12 refrigerant inlets

1. An evaporator for a sorption machine, comprising a heat exchanger provided with at least one tube, channel and/or combination of both passed through by a fluid, to which a refrigerant is at least partially applied,
wherein
the evaporator is filled with a porous material through which vapour can pass through and is at least partially in contact with the at least one tube, the channel and/or the combination.

2. The evaporator of claim 1,
wherein
the heat exchanger is provided with surface-enlarging tubular accessories or structures, in particular plates, nets, ribs, protrusions, 2- or 3-dimensional grid structures and/or fins.

3. The evaporator of claim 1,
wherein
the porous material is selected from the group consisting of sand, glass balls, glass fibres, clay, mineral wool, foam glass, cellulose, rigid foam, glass wool, metal wool or swarf, rock wool, slag wool, expanded glass, perlite, calcium silicate, natural pumice, ceramic fibres, ceramic foam, silicate foam, plaster foam, pyrogenic silicic acid, flax, polyester fibres, phenolic foam, felt or a mixture thereof.

4. The evaporator of claim 3,
wherein
the glass fibres are present in the form of glass fibre chips, cords, threads, rovings, mats, fabric and/or beads.

5. The evaporator of claim 1,
wherein
the porous material is present in a solid and/or liquid state in the evaporator.

6. The evaporator of claim 1,
wherein
the porous material is applied to the at least one tube, particularly by the material at least partially sheathing or coating the tube(s) of the heat exchanger.

7. The evaporator of claim 2,
wherein
the porous material is applied to the tubular accessories or on structures of the heat exchanger which enlarge the heat exchange surfaces.

8. The evaporator of claim 1,
wherein
a plurality of tubes or channels is arranged in the heat exchanger essentially in parallel causing gaps to be formed between them.

9. The evaporator of claim 8,
wherein
the porous material is at least partially present on the tube(s) and in the gaps.

10. The evaporator of claim 4,
wherein
glass fibre chips are at least partially of a length greater than a clearance between two fins or ribs.

11. The evaporator of claim 2,
wherein
the surface-enlarging tubular accessories and/or structures are porous.

12. The evaporator of claim 1,
wherein
the porous material has capillary forces.

13. The evaporator of claim 1,
wherein
a hydrophilic layer is applied to the heat exchanger and/or surface-enlarging tubular accessories and/or structures.

14. A method comprising providing a porous material wherein the porous material is a filling material in an evaporator.

15. The method of claim 14, wherein the evaporator comprises a heat exchanger provided with at least one tube, channel and/or combination of both passed through by a fluid, to which a refrigerant is at least partially applied,
wherein
the porous material fills the evaporator essentially completely and is in contact with the tube, channel and/or combination.

16. The method of claim 15,
wherein
the heat exchanger comprises surface-enlarging tubular accessories or structures, selected from a group consisting of plates, nets, ribs, protrusions, 2- or 3-dimensional grid structures and/or fins.

17. The method of claim 14,
wherein
the porous material is present as fibre and is selected from the a group consisting of metal fibres, plaster fibres, anhydrite fibres, felt fibres, tobermorite fibres, wollastonite fibres, xonotlite fibres, rock wool fibres, cotton fibres, cellulose fibres, polyester fibres, polyamide fibres, methacrylic ester fibres, polyacrylic fibres, nitrile fibres, polyethylene fibres, polypropylene fibres and/or silicate fibres, in particular glass fibres.

18. A method for producing an evaporator of claim 1 comprising providing
the porous material, and pouring it into the evaporator.

19. The method of claim 18,
wherein
the fibrous material is incorporated into the evaporator as a slurry.

20. The method of claim 18, wherein the porous material is a fibrous material.
